(19) United States
(12) Patent Application Publication
(10) Pub. No.: US 2003/0024659 A1
(43) Pub. Date: Feb. 6, 2003

(54) Roll-up blind with high mechanical strength, having thermal and acoustic insulation features

(76) Inventor: Rodolfo Begni, Brescia (IT)

Correspondence Address: MODIANO & ASSOCIATI, Via Meravigli, 16, Milano, 20123, IT

(21) Appl. No.: 10/178,246

(22) Filed: Jun. 25, 2002

(30) Foreign Application Priority Data
Aug. 1, 2001 (IT) MI2001A001672

(51) Int. Cl. E06B 3/12

(52) U.S. Cl. 160/235

(57) ABSTRACT

A roll-up blind with high mechanical strength, having thermal and acoustic insulation features, comprising a plurality of slats that can be mutually hinged, each slat being constituted by an outer profiled element made of aluminum and by an inner profiled element made of plastics which is coupled to the outer profiled element; the roll-up blind further comprises, on the inner face of the outer profiled element, a protrusion that is monolithic with the outer profiled element and forms an engagement seat for screws for the connection of end plates for the slats.

### BACKGROUND OF THE INVENTION

The present invention relates to a roll-up blind with high mechanical strength, having thermal and acoustic insulation features.

It is known that roll-up blinds have already been commercially available for some time which are provided with an outer profiled element made of aluminum to which an inner profiled element made of plastics, acting as a thermal and acoustic insulation element, is coupled.

In order to ensure the mutual transverse alignment of the slats and prevent transverse play of a slat with respect to the adjacent ones, end plates are used which are fixed by means of a self-tapping screw, such screw engaging a seat provided by the inner profiled element made of plastics.

This kind of solution, while being widely used, has the drawback that it does not allow optimum mechanical strength for the coupling of the plates and further it does not allow to provide blinds that are capable of withstanding any actions that attempt to extract the slats from their guide.

### SUMMARY OF THE INVENTION

The aim of the present invention is to solve the above problems, by providing a roll-up blind with high mechanical strength, having thermal and acoustic insulation features, that allows to have excellent strength in the coupling of the plates, absolutely preventing the possibility of mutual sliding of one slat with respect to the laterally adjacent ones.

Within this aim, an object of the invention is to provide a blind in which it is possible to provide means that prevent the extraction of the blind from the guides even in the presence of intense forces.

Another object of the present invention is to provide a blind that by way of its particular constructive characteristics is capable of giving the greatest assurances of reliability and safety in use.

Another object of the present invention is to provide a roll-up blind with high mechanical strength, having thermal and acoustic insulation features, that can be obtained easily starting from commonly commercially available elements and materials.

This aim and these and other objects that will become better apparent hereinafter are achieved by a roll-up blind with high mechanical strength, having thermal and acoustic insulation features, according to the invention, which comprises a plurality of slats that can be mutually hinged, each slat being constituted by an outer profiled element made of aluminum and by an inner profiled element made of plastics which is coupled to said outer profiled element, characterized in that it comprises, on an inner face of said outer profiled element, a protrusion that is monolithic with said outer profiled element and forms an engagement seat for screws for connection of end plates for said slats.

### BRIEF DESCRIPTION OF THE DRAWINGS

Further characteristics and advantages of the present invention will become better apparent from the following detailed description of a preferred but not exclusive embodiment of a roll-up blind with high mechanical strength, having thermal and acoustic insulation features, illustrated only by way of non-limitative example in the accompanying drawings, wherein:

FIG. 1 is a schematic exploded perspective view of a slat of the blind according to the invention;

FIG. 2 is a perspective view of the partially assembled slat, with the end plate shown in an exploded view;

FIG. 3 is a perspective view of the assembled slat;

FIG. 4 is a sectional view of the slat.

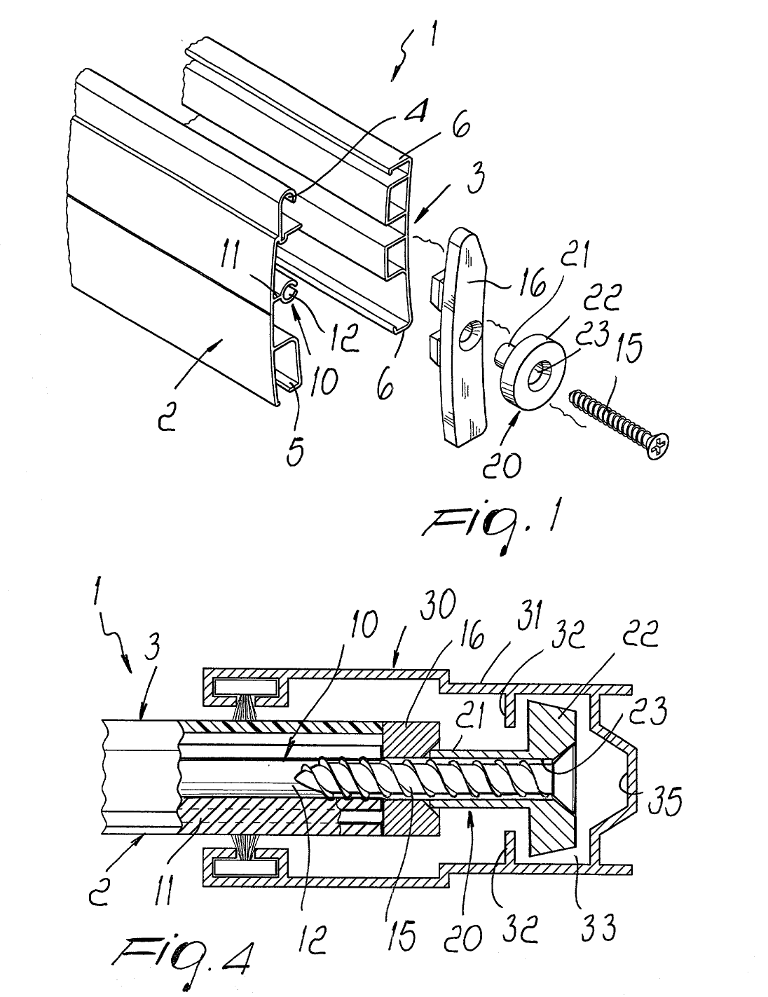

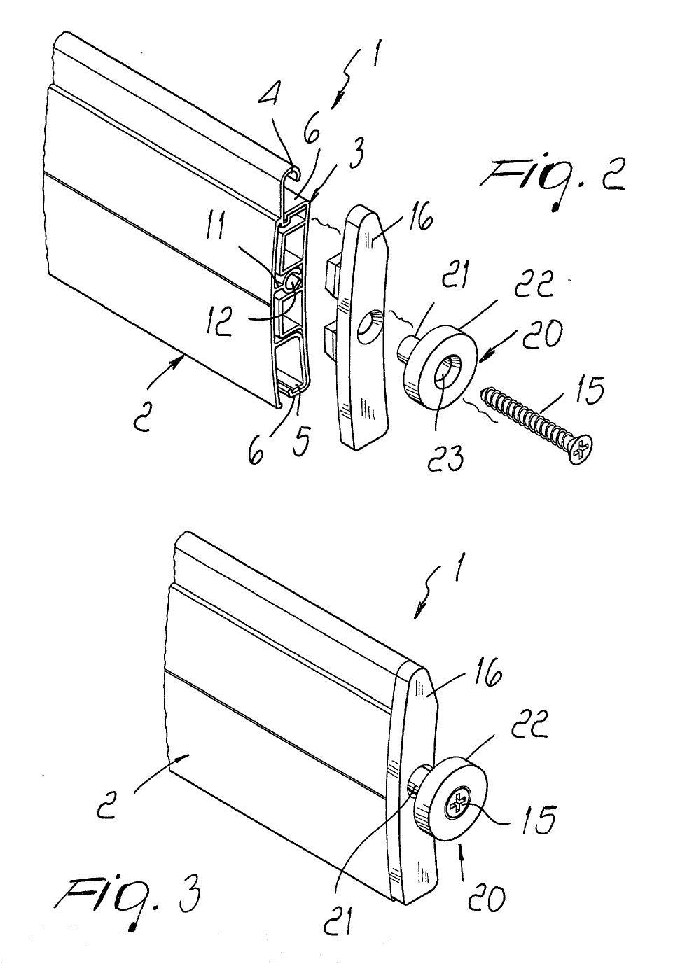

### DESCRIPTION OF THE PREFERRED EMBODIMENTS

With reference to the figures, the roll-up blind with high mechanical strength, having thermal and acoustic insulation features, according to the invention, comprises a plurality of slats, generally designated by the reference numeral 1, each of which is formed by an outer profiled element 2 made of aluminum, which is coupled to an inner profiled element 3 made of plastics.

The outer profiled element 2 forms, on its longitudinal edges, respectively a hook-shaped end 4 and a seat 5, so as to achieve a mutual coupling of one slat with respect to laterally adjacent slats.

The inner profiled element 3 has, at its ends, engagement edges 6 that allow to couple it to the outer profiled element 2.

The particularity of the invention consists in that on the inner face of the outer profiled element 2 there is a protrusion 10, which has a fin 11 for connection to the outer profiled element, which ends with a C-shaped seat 12 that acts as an engagement seat for screws 15 for the connection of a plate 16.

The end plate 16 is designed to constitute a stop element for the transverse sliding of the slats arranged side by side.

It is also possible to connect a retention element, generally designated by the reference numeral 20, which is constituted by a base tang 21 and by a wider disk-like portion 22, which form an axial hole 23 for the passage of the screw 15.

The retention element, by using a guide 30 of the type shown in FIG. 4, which has a U-shaped body 31 provided, proximate to the central portion, with delimiting walls 32 that form a seat 33 for the disk-like portion 22, allows to prevent the extraction of the slat from the guide 30 even in the presence of considerable forces.

Moreover, in the central portion of the U-shaped guide there is a recess 35, which allows to avoid interfering with the retention element 20 even if screws with a protruding head are used.

With the above described arrangement it is therefore evident that the invention achieves the intended aim and objects, and in particular it is stressed that the provision of the engagement seat for the plate directly monolithically with the outer profiled element made of aluminum allows to have a mechanical tightening of the screw that is certainly stronger because it self-taps directly into a metallic portion.

Further, the presence of the retention element 20 allows to provide greater mechanical strength and to prevent absolutely any possibility of extracting the slat from the guides even by applying considerable force.

The invention thus conceived is susceptible of numerous modifications and variations, all of which are within the scope of the inventive concept.

All the details may further be replaced with other technically equivalent elements.

In practice, the materials employed, as well as the contingent shapes and dimensions, may be any according to requirements.

The disclosures in Italian Patent Application No. MI2001A001672 from which this application claims priority are incorporated herein by reference.

What is claimed is:

1. A roll-up blind with high mechanical strength, having thermal and acoustic insulation features, comprising a plurality of slats that can be mutually hinged, each slat being constituted by an outer profiled element made of aluminum and by an inner profiled element made of plastics which is coupled to said outer profiled element, further comprising, on an inner face of said outer profiled element, a protrusion that is monolithic with said outer profiled element and forms an engagement seat for screws for connection of end plates for said slats.

2. The blind according to claim 1, wherein said outer profiled element has, on said inner face, a protrusion that is constituted by a fin for connection to the outer profiled element, which ends in said substantially C-shaped engagement seat.

3. The blind according to claim 1, further comprising a retention element that is associable with said end plates.

4. The blind according to claim 3, wherein said retention element comprises a base tang which ends, at one end, with a wider disk-like portion, said protrusion forming an axial hole for the passage of said connection screw.

5. The blind according to claim 4, wherein said disk-like portion can be accommodated in a seat for the disk-like portion, which is formed in a guide for the blind which has a U-shaped body that has, proximate to a central portion, walls that form said seat for the disk-like portion.

6. The blind according to claim 5, further comprising, in said central portion, a recess that is suitable to form a region for accommodating any connection screws that have a protruding head.
